(19) United States
(12) Patent Application Publication
(10) Pub. No.: US 2023/0096963 A1
(43) Pub. Date: Mar. 30, 2023

(54) Increasing Drilling Accuracy While Increasing Drilling Rates

(71) Applicant: Halliburton Energy Services, Inc., Houston, TX (US)

(72) Inventors: Nazli Demirer, Tomball, TX (US); Umut Zalluhoglu, The Woodlands, TX (US); Robert P. Darbe, Houston, TX (US)

(73) Assignee: Halliburton Energy Services, Inc., Houston, TX (US)

(21) Appl. No.: 17/698,137

(22) Filed: Mar. 18, 2022

Related U.S. Application Data
(60) Provisional application No. 63/248,014, filed on Sep. 24, 2021.

(51) Int. Cl. E21B 44/00; G06Q 10/06

(52) U.S. Cl. CPC E21B 44/00; G06Q 10/06315; E21B 2200/20

(57) ABSTRACT

A method or system for increasing drilling accuracy. The method and system may comprise generating one or more measurements of at least a first drilling parameter and a second drilling parameter, determining a relationship between the first drilling parameter and the second drilling parameter, creating one or more constraints from the relationship, and minimizing a cost function using the one or more constraints. The method and system may further comprise calculating one or more control commands based at least in part on the minimizing the cost function and the one or more constraints and updating a drilling operation according to the one or more control commands.

### BACKGROUND

The oil and gas industry may use wellbores as fluid conduits to access subterranean deposits of various fluids and minerals which may include hydrocarbons. There may be a direct correlation between the productivity of a wellbore and the interfacial surface area through which the wellbore intersects a target subterranean formation. For this reason, it may be economically desirable to increase the length of a drilled section within a target subterranean formation by means of extending a horizontal, slant-hole, or deviated wellbore through the target subterranean formation. Additionally, horizontal, slant-hole, and deviated drilling techniques may be utilized in operational contexts where the surface location is laterally offset from the target subterranean formation such that the target subterranean formation may not be accessible by vertical drilling alone.

Due to leasing restrictions associated with developing a subterranean asset it may be important to pre-plan and adhere to a well-specific wellbore trajectory in order to maximize the extended length of the wellbore through the target subterranean formation. Additionally, constructing a smooth wellbore profile may be a priority if further operations may be utilized to complete and produce the well. Unintentional departures from the planned wellbore trajectory, which may include “bit walking,” may result in hole deviations. In non-limiting terms, hole deviations may be caused by geological heterogeneity, property variations in geological layers, formation dip angles, geological folding and faulting, drill-bit type, bit hydraulics, improper hole cleaning, drill string characteristics, high ROP, and human error. Unplanned hole deviations may result in “wellbore tortuosity,” which may in the very least create problems with future well operations including the placement and utilization of casing, completion tools, logs, and/or production and artificial lift equipment.

During drilling operations, both expediency and accuracy of the wellbore progression may be operational priorities. These may be considered competing priorities in that increasing ROP may also increase wellbore tortuosity which may further hinder or even prohibit the successful completion of future wellbore operations in the deviated well. Currently there is no methodology or system to identify operational set points to achieve the two objectives simultaneously.

### BRIEF DESCRIPTION OF THE DRAWINGS

These drawings illustrate certain aspects of some examples of the present disclosure and should not be used to limit or define the disclosure.

FIG. 1 illustrates an example of a drilling system and operation;

FIG. 2 illustrates is a schematic view of an information handling system;

FIG. 3 illustrates another schematic view of and information handling system;

FIG. 4 illustrates a schematic view of a network;

FIG. 5 illustrates a workflow which may be used to generate drilling parameters;

FIG. 6 illustrates an example graph of dogleg severity vs. weight on bit;

FIG. 7 illustrates a workflow which may be used to select the weight on bit for a drilling operation; and

FIGS. 8A and 8B illustrate graphs resulting from simulation results.

### DETAILED DESCRIPTION

This disclosure details methods and systems to identify operational set points for a directional, deviated, or slant-hole drilling operation. Directional drilling may be advantageous when it is desirable to redirect a wellbore from a substantially vertical orientation to a horizontal orientation. In some examples the redirection of the wellbore trajectory may take place over a laterally restricted distance. Methods and systems discussed below may determine operational set points or control commands which may, simultaneously, allow for the fastest possible rate-of-penetration (“ROP”) while adequately adhering to a planned wellbore trajectory. This may be performed by characterizing a relationship between a set of drilling parameters. A receding horizon optimal control problem may be used to solve for the operational set points or control commands along a prediction horizon. The solution from the receding horizon optimal control problem may generate control commands such as weight-on-bit (“WOB”), steering ratio, dog-leg severity, flow rate, rotations per minute (“RPM”) or the drilling assembly and/or bit, and toolface (“TF”). These control commands may enable a drilling system to quickly drill to a predefined target along a predefined trajectory.

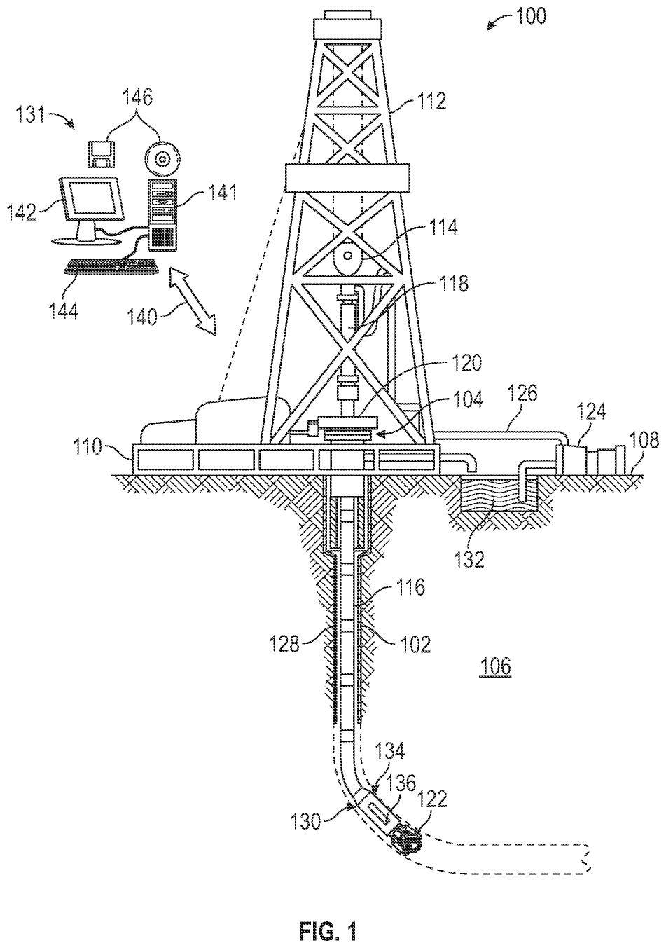

FIG. 1 illustrates an example of drilling system 100. As illustrated, wellbore 102 may extend from a wellhead 104 into a subterranean formation 106 from a surface 108. Generally, wellbore 102 may include horizontal, vertical, slanted, curved, and other types of wellbore geometries and orientations. Wellbore 102 may be cased or uncased. In examples, wellbore 102 may include a metallic member. By way of example, the metallic member may be a casing, liner, tubing, or other elongated steel tubular disposed in wellbore 102.

As illustrated, wellbore 102 may extend through subterranean formation 106. As illustrated in FIG. 1, wellbore 102 may extend generally vertically into the subterranean formation 106, however, wellbore 102 may extend at an angle through subterranean formation 106, such as horizontal and slanted wellbores. For example, although FIG. 1 illustrates a vertical or low inclination angle well, high inclination angle or horizontal placement of the well and equipment may be possible. It should further be noted that while FIG. 1 generally depicts land-based operations, those skilled in the art may recognize that the principles described herein are equally applicable to subsea operations that employ floating or sea-based platforms and rigs, without departing from the scope of the disclosure.

As illustrated, a drilling platform 110 may support a derrick 112 having a traveling block 114 for raising and lowering drill string 116. Drill string 116 may include, but is not limited to, drill pipe and coiled tubing, as generally known to those skilled in the art. A kelly 118 may support drill string 116 as it may be lowered through a rotary table 120. A drill bit 122 may be attached to the distal end of drill string 116 and may be driven either by a downhole motor, a rotary steerable system (“RSS”), and/or via rotation of drill string 116 from surface 108. Without limitation, drill bit 122 may include, roller cone bits, PDC bits, natural diamond bits, any hole openers, reamers, coring bits, and the like. As drill bit 122 rotates, it may create and extend wellbore 102 that penetrates various subterranean formations 106. A pump 124 may circulate drilling fluid through a feed pipe 126 through kelly 118, downhole through interior of drill string 116, through orifices in drill bit 122, back to surface 108 via annulus 128 surrounding drill string 116, and into a retention pit 132.

With continued reference to FIG. 1, drill string 116 may begin at wellhead 104 and may traverse wellbore 102. Drill bit 122 may be attached to a distal end of drill string 116 and may be driven, for example, either by a downhole motor and/or via rotation of drill string 116 from surface 108. In a non-limiting example, the weight of drill string 116 and bottom hole assembly may be controlled and measured while drill bit 122 is disposed within wellbore 102. In further examples, drill bit 122 may or may not be in contact with the bottom of wellbore 102. Drill bit 122 may be allowed to contact the bottom of wellbore 102 with varying amounts of weight applied to drill bit 122. The weight of drill string 116 may be measured at the surface of wellbore 102 and may be referred to as the “hook load.” The difference in the hook load when drill bit 122 is suspended just above the bottom of wellbore 102 and the hook load when drill bit 122 is in contact with the bottom of wellbore 102 may be referred to as the weight-on-bit (“WOB”). Both the hook load and the weight-on-bit may be considered drilling parameters. In some examples the hook load may be measured by a hoisting system or a hook load sensor. In some examples, the hook load is measured at the surface by a sensor disposed at the surface of drilling system 100. Drill bit 122 may be a part of bottom hole assembly 130 at the distal end of drill string 116. In some examples, bottom hole assembly 130 may further include tools for directional drilling applications. In other examples, directional drilling tools may be disposed anywhere along the drill string assembly. In further examples, directional drilling tools may be disposed within the wellbore using wireline, electric line, or slick line. As will be appreciated by those of ordinary skill in the art, bottom hole assembly 130 may include directional drilling tools including but not limited to a measurement-while drilling (MWD) and/or logging-while drilling (LWD) system, magnetometers, accelerometers, agitators, bent subs, orienting subs, mud motors, rotary steerable systems (RSS), jars, vibration reduction tools, roller reamers, pad pushers, non-magnetic drilling collars, whipstocks, push-the-bit systems, point-the-bit systems, directional steering heads and other directional drilling tools. Directional drilling tools may be disposed anywhere along the drill string assembly including at the portion distal to the drilling right which may be known as the Bottom hole assembly 130 may comprise any number of tools, transmitters, and/or receivers to perform downhole measurement operations. In some scenarios, these downhole measurements produce drilling parameters which may be used to guide the drilling operation. For example, as illustrated in FIG. 1, bottom hole assembly 130 may include a measurement assembly 134. It should be noted that measurement assembly 134 may make up at least a part of bottom hole assembly 130. Without limitation, any number of different measurement assemblies, communication assemblies, battery assemblies, and/or the like may form bottom hole assembly 130 with measurement assembly 134. Additionally, measurement assembly 134 may form bottom hole assembly 130 itself. In examples, measurement assembly 134 may comprise at least one sensor 136, which may be disposed at the surface of measurement assembly 134. It should be noted that while FIG. 1 illustrates a single sensor 136, there may be any number of sensors disposed on or within measurement assembly 134. Without limitation, sensors may be referred to as a transceiver. Further, it should be noted that there may be any number of sensors disposed along bottom hole assembly 130 at any degree from each other. In examples, sensors 136 may also include backing materials and matching layers. It should be noted that sensors 136 and assemblies housing sensors 136 may be removable and replaceable, for example, in the event of damage or failure.

Without limitation, bottom hole assembly 130 may be connected to and/or controlled by information handling system 131, which may be disposed on surface 108. Without limitation, information handling system 131 may be disposed down hole in bottom hole assembly 130. Processing of information recorded may occur down hole and/or on surface 108. Processing occurring downhole may be transmitted to surface 108 to be recorded, observed, and/or further analyzed. Additionally, information recorded on information handling system 131 that may be disposed down hole may be stored until bottom hole assembly 130 may be brought to surface 108. In examples, information handling system 131 may communicate with bottom hole assembly 130 through a communication line (not illustrated) disposed in (or on) drill string 116. In examples, wireless communication may be used to transmit information back and forth between information handling system 131 and bottom hole assembly 130. Information handling system 131 may transmit information to bottom hole assembly 130 and may receive as well as process information recorded by bottom hole assembly 130. In examples, a downhole information handling system (not illustrated) may include, without limitation, a microprocessor or other suitable circuitry, for estimating, receiving, and processing signals from bottom hole assembly 130. Downhole information handling system (not illustrated) may further include additional components, such as memory, input/output devices, interfaces, and the like. In examples, while not illustrated, bottom hole assembly 130 may include one or more additional components, such as analog-to-digital converter, filter, and amplifier, among others, that may be used to process the measurements of bottom hole assembly 130 before they may be transmitted to surface 108. Alternatively, raw measurements from bottom hole assembly 130 may be transmitted to surface 108.

Any suitable technique may be used for transmitting signals from bottom hole assembly 130 to surface 108, including, but not limited to, wired pipe telemetry, mud-pulse telemetry, acoustic telemetry, and electromagnetic telemetry. While not illustrated, bottom hole assembly 130 may include a telemetry subassembly that may transmit telemetry data to surface 108. At surface 108, pressure sensors (not shown) may convert the pressure signal into electrical signals for a digitizer (not illustrated). The digitizer may supply a digital form of the telemetry signals to information handling system 131 via a communication link 140, which may be a wired or wireless link. The telemetry data may be analyzed and processed by information handling system 131.

As illustrated, communication link 140 (which may be wired or wireless, for example) may be provided that may transmit data from bottom hole assembly 130 to an information handling system 131 at surface 108. Information handling system 131 may include a personal computer 141, a video display 142, a keyboard 144 (i.e., other input devices), and/or non-transitory computer-readable media 146 (e.g., optical disks, magnetic disks) that can store code representative of the methods described herein. In addition to, or in place of processing at surface 108, processing may occur downhole. As discussed below, methods may be utilized by information handling system 131 to facilitate maximizing the ROP of drilling system 100 while minimizing unplanned deviations from the planned well trajectory.

Information handling system 131 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 131 may be a personal computer, a network storage device, or any other suitable device and may vary in size, shape, performance, functionality, and price. Information handling system 131 may include random access memory (RAM), one or more processing resources such as a central processing unit 134 (CPU) or hardware or software control logic, ROM, and/or other types of nonvolatile memory. Additional components of the information handling system 131 may include one or more disk drives 146, output devices 142, such as a video display, and one or more network ports for communication with external devices as well as an input device 144 (e.g., keyboard, mouse, etc.). Information handling system 131 may also include one or more buses operable to transmit communications between the various hardware components.

Alternatively, systems and methods of the present disclosure may be implemented, at least in part, with non-transitory computer-readable media. Non-transitory computer-readable media may include any instrumentality or aggregation of instrumentalities that may retain data and/or instructions for a period of time. Non-transitory computer-readable media may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

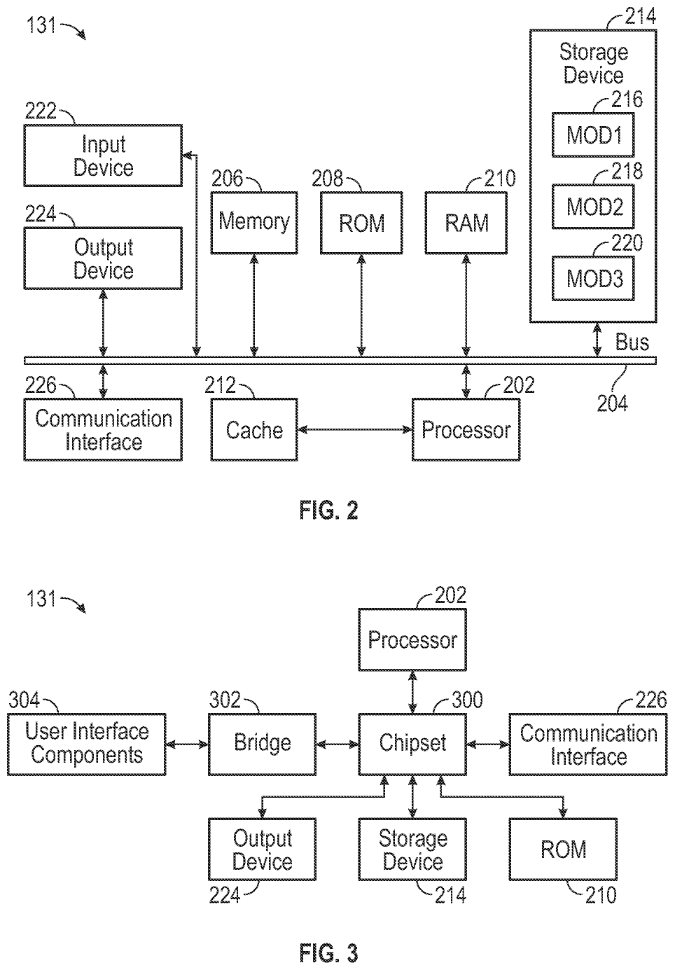

FIG. 2 illustrates an example information handling system 131 which may be employed to perform various steps, methods, and techniques disclosed herein. Persons of ordinary skill in the art will readily appreciate that other system examples are possible. As illustrated, information handling system 131 includes a processing unit (CPU or processor) 202 and a system bus 204 that couples various system components including system memory 206 such as read only memory (ROM) 208 and random-access memory (RAM) 210 to processor 202. Processors disclosed herein may all be forms of this processor 202. Information handling system 131 may include a cache 212 of high-speed memory connected directly with, in close proximity to, or integrated as part of processor 202. Information handling system 131 copies data from memory 206 and/or storage device 214 to cache 212 for quick access by processor 202. In this way, cache 212 provides a performance boost that avoids processor 202 delays while waiting for data. These and other modules may control or be configured to control processor 202 to perform various operations or actions. Other system memory 206 may be available for use as well. Memory 206 may include multiple different types of memory with different performance characteristics. It may be appreciated that the disclosure may operate on information handling system 131 with more than one processor 202 or on a group or cluster of computing devices networked together to provide greater processing capability. Processor 202 may include any general-purpose processor and a hardware module or software module, such as first module 216, second module 218, and third module 220 stored in storage device 214, configured to control processor 202 as well as a special-purpose processor where software instructions are incorporated into processor 202. Processor 202 may be a self-contained computing system, containing multiple cores or processors, a bus, memory controller, cache, etc. A multi-core processor may be symmetric or asymmetric. Processor 202 may include multiple processors, such as a system having multiple, physically separate processors in different sockets, or a system having multiple processor cores on a single physical chip. Similarly, processor 202 may include multiple distributed processors located in multiple separate computing devices but working together such as via a communications network. Multiple processors or processor cores may share resources such as memory 206 or cache 212 or may operate using independent resources. Processor 202 may include one or more state machines, an application specific integrated circuit (ASIC), or a programmable gate array (PGA) including a field PGA (FPGA).

Each individual component discussed above may be coupled to system bus 204, which may connect each and every individual component to each other. System bus 204 may be any of several types of bus structures including a memory bus or memory controller, a peripheral bus, and a local bus using any of a variety of bus architectures. A basic input/output (BIOS) stored in ROM 208 or the like, may provide the basic routine that helps to transfer information between elements within information handling system 131, such as during start-up. Information handling system 131 further includes storage devices 214 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 214 may include software modules 216, 218, and 220 for controlling processor 202. Information handling system 131 may include other hardware or software modules. Storage device 214 is connected to the system bus 204 by a drive interface. The drives and the associated computer-readable storage devices provide nonvolatile storage of computer-readable instructions, data structures, program modules and other data for information handling system 131. In one aspect, a hardware module that performs a particular function includes the software component stored in a tangible computer-readable storage device in connection with the necessary hardware components, such as processor 202, system bus 204, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 131 is a small, handheld computing device, a desktop computer, or a computer server. When processor 202 executes instructions to perform “operations”, processor 202 may perform the operations directly and/or facilitate, direct, or cooperate with another device or component to perform the operations.

As illustrated, information handling system 131 employs storage device 214, which may be a hard disk or other types of computer-readable storage devices which may store data that are accessible by a computer, such as magnetic cassettes, flash memory cards, digital versatile disks (DVDs), cartridges, random access memories (RAMs) 210, read only memory (ROM) 208, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 131, an input device 222 represents any number of input mechanisms, such as a microphone for speech, a touch-sensitive screen for gesture or graphical input, keyboard, mouse, motion input, speech and so forth. An output device 224 may also be one or more of a number of output mechanisms known to those of skill in the art. In some instances, multimodal systems enable a user to provide multiple types of input to communicate with information handling system 131. Communications interface 226 generally governs and manages the user input and system output. There is no restriction on operating on any particular hardware arrangement and therefore the basic hardware depicted may easily be substituted for improved hardware or firmware arrangements as they are developed.

As illustrated, each individual component describe above is depicted and disclosed as individual functional blocks. The functions these blocks represent may be provided through the use of either shared or dedicated hardware, including, but not limited to, hardware capable of executing software and hardware, such as a processor 202, that is purpose-built to operate as an equivalent to software executing on a general-purpose processor. For example, the functions of one or more processors presented in FIG. 2 may be provided by a single shared processor or multiple processors. (Use of the term “processor” should not be construed to refer exclusively to hardware capable of executing software.) Illustrative examples may include microprocessor and/or digital signal processor (DSP) hardware, read-only memory (ROM) 208 for storing software performing the operations described below, and random-access memory (RAM) 210 for storing results. Very large-scale integration (VLSI) hardware examples, as well as custom VLSI circuitry in combination with a general-purpose DSP circuit, may also be provided.

FIG. 3 illustrates an example information handling system 131 having a chipset architecture that may be used in executing the described method and generating and displaying a graphical user interface (GUI). Information handling system 131 is an example of computer hardware, software, and firmware that may be used to implement the disclosed technology. Information handling system 131 may include a processor 202, representative of any number of physically and/or logically distinct resources capable of executing software, firmware, and hardware configured to perform identified computations. Processor 202 may communicate with a chipset 300 that may control input to and output from processor 202. In this example, chipset 300 outputs information to output device 224, such as a display, and may read and write information to storage device 214, which may include, for example, magnetic media, and solid-state media. Chipset 300 may also read data from and write data to RAM 210. A bridge 302 for interfacing with a variety of user interface components 304 may be provided for interfacing with chipset 300. Such user interface components 304 may include a keyboard, a microphone, touch detection and processing circuitry, a pointing device, such as a mouse, and so on. In general, inputs to information handling system 131 may come from any of a variety of sources, machine generated and/or human generated.

Chipset 300 may also interface with one or more communication interfaces 226 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 202 analyzing data stored in storage device 214 or RAM 210. Further, information handling system 131 receive inputs from a user via user interface components 304 and execute appropriate functions, such as browsing functions by interpreting these inputs using processor 202.

In examples, information handling system 131 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

During drilling operations, information handling system 131 may process different types of the real time data originated from varied sampling rates and various sources, such as diagnostics data, sensor measurements, operations data, and/or the like. These measurements from wellbore 102, BHA 130, measurement assembly 134, and sensor 136 may allow for information handling system 131 to perform real-time health assessment of the drilling operation. Drilling tools and equipment may further comprise a variety of sensors which may be able to provide real-time measurements and data relevant to steering the wellbore in adherence to a well plan. In some examples this drilling equipment may include drilling rigs, top drives, drilling tubulars, mud motors, gyroscopes, accelerometers, magnetometers, bent housing subs, directional steering heads, rotary steerable systems (“RSS”), whipstocks, push-the-bit systems, point-the-bit systems, and other directional drilling tools. In the context of drilling operations, “real-time,” may be construed as monitoring, gathering, assessing, and/or utilizing data contemporaneously with the execution of the drilling operation. Real-time operations may further comprise modifying the initial design or execution of the planned operation in order to modify a well plan of a drilling operation. In some examples, the modifications to the drilling operation may occur through automated or semi-automated processes. An example of an automated drilling process may include relaying or downlinking a set of operational commands (control commands) to an RSS in order to modify a drilling operation to achieve a certain objective. In other examples, operational commands (control commands) may be automatically relayed to the top drive. In other examples, the operational commands (control commands) may be relayed to the rig personnel for review prior to implementation. In some examples, drilling objectives may be incorporated into the drilling operation through minimization of a cost function, which will be discussed in further detail below.

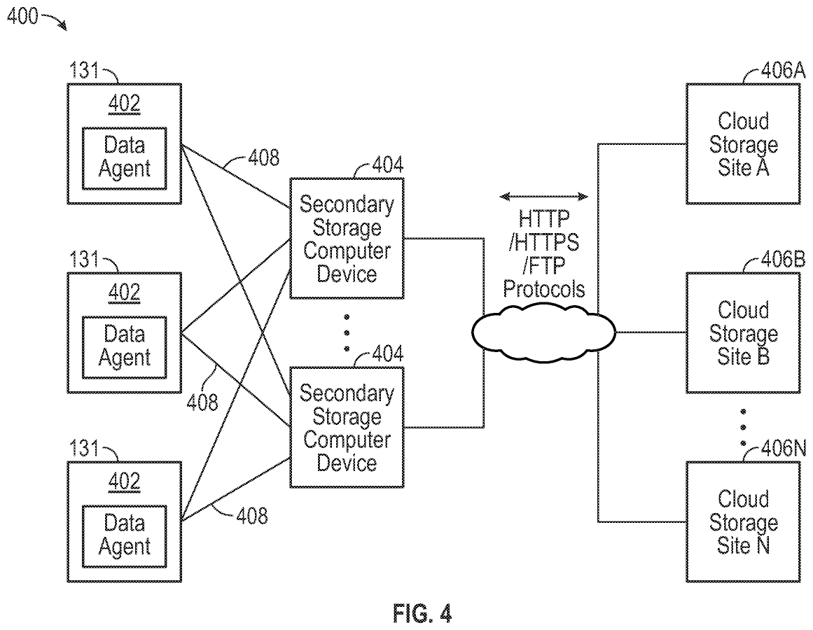

FIG. 4 illustrates an example of one arrangement of resources in a computing network 400 that may employ the processes and techniques described herein, although many others are of course possible. As noted above, an information handling system 131, as part of their function, may utilize data, which includes files, directories, metadata (e.g., access control list (ACLS) creation/edit dates associated with the data, etc.), and other data objects. The data on the information handling system 131 is typically a primary copy (e.g., a production copy). During a copy, backup, archive or other storage operation, information handling system 131 may send a copy of some data objects (or some components thereof) to a secondary storage computing device 404 by utilizing one or more data agents 402.

A data agent 402 may be a desktop application, website application, or any software-based application that is run on information handling system 131. As illustrated, information handling system 131 may be disposed at any rig site (e.g., referring to FIG. 1) or repair and manufacturing center. The data agent may communicate with a secondary storage computing device 404 using communication protocol 408 in a wired or wireless system. The communication protocol 408 may function and operate as an input to a website application. In the website application, field data related to pre- and post-operations, generated DTCs, notes, and the like may be uploaded. Additionally, information handling system 131 may utilize communication protocol 408 to access processed measurements, operations with similar DTCs, troubleshooting findings, historical run data, and/or the like. This information is accessed from secondary storage computing device 404 by data agent 402, which is loaded on information handling system 131.

Secondary storage computing device 404 may operate and function to create secondary copies of primary data objects (or some components thereof) in various cloud storage sites 406A-N. Additionally, secondary storage computing device 404 may run determinative algorithms on data uploaded from one or more information handling systems 131, discussed further below. Communications between the secondary storage computing devices 404 and cloud storage sites 406A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 506A-N, the secondary storage computing device 404 may also perform local content indexing and/or local object-level, sub-object-level or block-level deduplication when performing storage operations involving various cloud storage sites 406A-N. Cloud storage sites 406A-N may further record and maintain DTC code logs for each downhole operation or run, map DTC codes, store repair and maintenance data, store operational data, and/or provide outputs from determinative algorithms that are located in cloud storage sites 406A-N. In a non-limiting example, this type of network may be utilized as a platform to store, backup, analyze, import, and preform extract, transform and load (“ETL”) processes to the data gathered during a drilling operation.

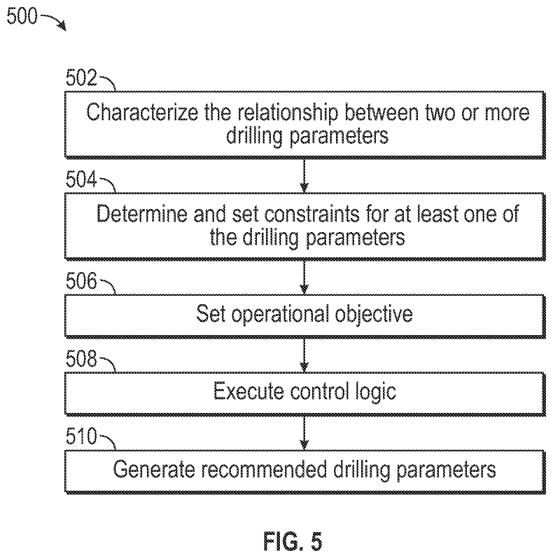

FIG. 5 illustrates workflow 500 for maximizing one or more drilling parameters while maintaining an operational objective. One such example may include maximizing ROP while maintaining low wellbore tortuosity. When re-directing a wellbore from a vertical to a horizontal orientation, which may be referred to as “building the curve,” an example operational objective may include steering the wellbore such that it tracks accurately with the well plan to minimize tortuosity. The well plan indicates a desired well path (or trajectory) to form the wellbore (e.g., wellbore 102 on FIG. 1). In a non-limiting example, the well plan may include a table of parameters that vary sequentially to build the curvature of a well in relation to the total vertical depth of the wellbore. These parameters may include metrics such as attitude (inclination and azimuth), dog-leg severity (“DLS”), weight-on-bit (“WOB”), rate of penetration (“ROP”), build rate (“BR”), wellbore coordinates, and other directional drilling parameters. Developing a particular DLS may be directly correlated to the “build rate,” (“BR”) and “walk rate” (“WR”) abilities of the directional tools. The BR of a wellbore may relate to changes in inclination while the WR may relate to changes in azimuth. WOB may be the downward force seen at the rock-bit interface and may be directly related to ROP. As previously mentioned, directional drilling systems may operate completely autonomously, may involve human intervention, or may utilize a combination of autonomous operations and human intervention. As such, the control commands (operational drilling parameters) determined from the controller may be relayed to technical staff for review prior to proceeding with the drilling operation, or the control commands may be relayed directly to the drilling tools and/or drilling equipment for continued autonomous operations. As such, data acquired before or during the drilling operation may be used to modify the drilling process in order to extend the wellbore through the subterranean formation according to a desired well plan or operational objective. It should be noted that workflow 500 may be performed on an information handling system 131 using the methods and systems discussed above. Workflow 500 may be utilized, without limitation, with either mud motors or rotary steerable systems for wells drilled either onshore or offshore. Workflow 500 may begin by characterizing a relationship between two or more drilling parameters as depicted in block 502. In some examples, these drilling parameters may include weight-on-bit (“WOB”), dog-leg severity (“DLS”), build rate (“BR”), steering ratio (“SR”), and/or tool face (“TF”). A numerical relationship between two or more drilling parameters may be developed to create a foundational correlation from which one or more constraints may be selected. Incorporating these constraints with the minimization of a cost function may allow for operational drilling parameters or control commands to be determined. The capabilities of the drilling parameters and the drilling assembly may vary with the inclination at which the wellbore is being drilled. For example, the BR or DLS capabilities of a particular drilling assembly may vary with the inclination at which the well is being drilled. The following describes an example where a relationship is created between at least WOB and DLS (or, alternatively BR). The Inclination dynamics may be related to DLS where the relationship with WOB with a TF of zero (0) may be given as:

$$\frac{d}{d ξ} {κ}_{Θ} ( ξ ) = - \frac{1}{τ} {κ}_{Θ} ( ξ ) + \frac{1}{τ} {ω}_{1} \prod ( ξ ) + \frac{1}{τ} {ω}_{0} \qquad ( 1 )$$

where a given measured depth may be denoted as ξ, the build rate (“BR”) may be denoted by κ_{Θ}, and the WOB may be denoted by Π. An additional variable τ, may be used to denote the time constant for tool response which is a parameter characterizing the response to a first order step input.

In some examples, the relationship between the drilling parameters may be linear, for example the relationship between BR and WOB may be such that:

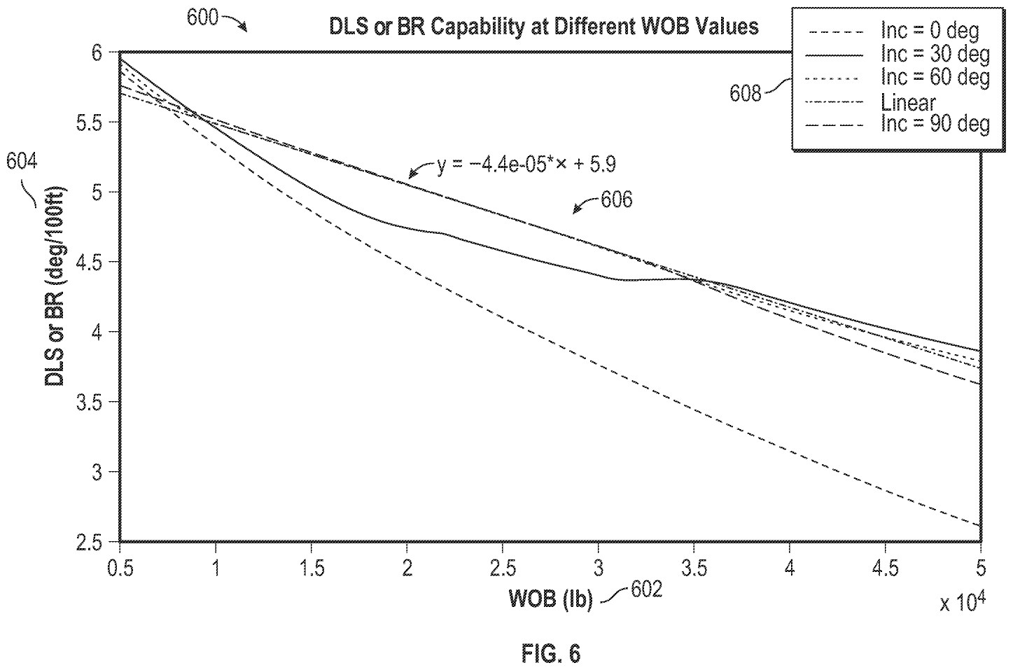

ω₁Π+ω₀ (2)

where slope, ω₁ and intercept, ω₀ may be obtained empirically by observing and recording the tool's DLS capability for a wide range of WOB values. In some examples, the relationship developed between the drilling parameters may include non-linear relationships. In other examples, the relationship between the drilling parameters may include in-direct relationships. As previously noted, there may be a direct correlation between BR and DLS. An example of the relationship 606 between BR and WOB plot may be depicted in plot 600 of FIG. 6. As may be seen in FIG. 6, the relationship 606 may be an inverse correlation between the independent variable of WOB 602 and the dependent variable of DLS 604 or alternatively the independent variable of WOB 602 and the dependent variable of BR 604. In some examples, increasing the WOB may result in less wellbore curvature, or DLS capability through the associated wellbore section. The relationship 606 between WOB 602 and DLS 604, or alternatively between WOB 602 and BR 604 may further vary as a function of the wellbore inclination 608. As such, there may be a plurality of relationships between WOB 602 and DLS 604, or BR 604 developed for a range of wellbore inclinations. In some examples, one or more nominal relationships between two or more drilling parameters may be developed offline. For example, a nominal relationship between DLS and WOB or BR and WOB may be developed prior to drilling the curved section of a wellbore or may be developed based on limited data from the specific well being drilled. In a non-limiting example, the relationships 606 developed offline may be determined from drilling models or previously acquired data. In some examples, previously acquired data may be referred to as historical data. In further examples the previously acquired data may come from previously drilled wells in a region. Additionally, the previously acquired data may come from wells considered to be analogous to the well which is to be drilled. The relationships 606 developed offline, which may be referred to as nominal relationships, may further be updated and/or improved by incorporation of additional, new, and/or real-time data.

The change in WOB may be mathematically modeled as:

$$Δ \prod ( ξ ) = \frac{d}{d ξ} \prod ( ξ ) \qquad ( 3 )$$

where the equation relating inclination dynamics to WOB and TF may be written as follows:

$$\frac{d}{d ξ} [ \begin{matrix}{κ}_{Θ} \\ Θ \\ \prod \end{matrix} ] ( ξ ) = [ \begin{matrix}- 1 / τ & 0 & {ω}_{1} / τ \\ 1 & 0 & 0 \\ 0 & 0 & 0\end{matrix} ] [ \begin{matrix}{κ}_{Θ} \\ Θ \\ \prod \end{matrix} ] ( ξ ) + [ \begin{matrix}0 \\ 0 \\ 1\end{matrix} ] Δ \prod ( ξ ) + [ \begin{matrix}{ω}_{0} / τ \\ 0 \\ 0\end{matrix} ] \qquad ( 4 )$$

The base equation may further be modified as below, when the offset angle of the TF is expanded to include angles ranging from 0 to 360 degrees:

$$\frac{d}{d ξ} {κ}_{Θ} ( ξ ) = - \frac{1}{τ} {κ}_{Θ} ( ξ ) + \frac{1}{τ} ( {ω}_{1} \prod ( ξ ) + {ω}_{0} ) cos ( Γ ) \qquad ( 5 )$$

where Γ is the TF in degrees.

The relationship between the two or more drilling parameters as developed in block 502 may subsequently be constrained by one or more constraints which may be determined in block 504. In a non-limiting example, the one or more constraints which may be set in block 504 may comprise of drilling parameters such as WOB, DLS, TF, or steering ratio. These constraints may also be referred to as “control parameters.” The constraints utilized in block 504 may be determined according to operational assessments of the directional drilling system as illustrated in FIG. 6. In a non-limiting scenario, an example control parameter, labelled p, may be introduced. As previously described a relationship may be formed between two or more drilling parameters. In the following example, p is a linear function of WOB and TF as follows:

p=ω₁Π(ξ)+ω₀ (6)

Control parameter p, which may be a vector, may further be broken into components related to the inclination (u_{Θ}) and pseudo-azimuth (u_{Φ}) of the actualized wellbore trajectory as:

μ_{Θ}=p cos(Γ) (7)

μ_{Φ}=p sin(Γ) (8)

With the incorporation of Equation (7), describing u_{Θ} and Equation (8), describing u_{Φ}, Equation (5) may be re-written as:

$$\frac{d}{d ξ} [ \begin{matrix}{κ}_{Θ} \\ Θ\end{matrix} ] ( ξ ) = [ \begin{matrix}- 1 / τ & 0 \\ 1 & 0\end{matrix} ] [ \begin{matrix}{κ}_{Θ} \\ Θ\end{matrix} ] ( ξ ) + [ \begin{matrix}1 / τ \\ 0\end{matrix} ] {𝓊}_{Θ} \qquad ( 9 )$$

$$\frac{d}{d ξ} [ \begin{matrix}{κ}_{Φ} \\ Φ\end{matrix} ] ( ξ ) = [ \begin{matrix}- 1 / τ & 0 \\ 1 & 0\end{matrix} ] [ \begin{matrix}{κ}_{Φ} \\ Φ\end{matrix} ] ( ξ ) + [ \begin{matrix}1 / τ \\ 0\end{matrix} ] {𝓊}_{Φ} \qquad ( 10 )$$

Once the constraints for block 504 are determined and set, one or more operational objectives may subsequently be set as depicted in block 506. One or more operational objectives may be determined and utilized to solve the foregoing componentized equations to achieve a specific drilling objective. With reference to Workflow 500, block 506 incorporates the selection of an operational objective, where in a non-limiting example, the optimization parameter may be a function of ROP or WOB. The bounds for control parameter p, may further be developed as follows with the selection of an upper bound (Πᵤ) and lower bound (Πₗ):

p_{μ}=ω₁Π_{μ}+ω₀, [symbol] =ω₁ [symbol] +ω₀ (11)

\sqrt{μ_{Θ}²+μ_{Φ}²}≤pᵤ (12)

where u is a state of the control input. Incorporating Equations (11) and (12) with Equations (9) and (10) may result in the following formulation:

$$\frac{d}{d ξ} [ \begin{matrix}{κ}_{Θ} \\ Θ \\ {𝓊}_{Θ}\end{matrix} ] ( ξ ) = [ \begin{matrix}- 1 / τ & 0 & 1 / τ \\ 1 & 0 & 0 \\ 0 & 0 & 0\end{matrix} ] [ \begin{matrix}{κ}_{Θ} \\ Θ \\ {𝓊}_{Θ}\end{matrix} ] ( ξ ) + [ \begin{matrix}0 \\ 0 \\ 1\end{matrix} ] {δ𝓊}_{Θ} ( ξ ) \qquad ( 13 )$$

$$\frac{d}{d ξ} [ \begin{matrix}{κ}_{Φ} \\ Φ \\ {𝓊}_{Φ}\end{matrix} ] ( ξ ) = [ \begin{matrix}- 1 / τ & 0 & 1 / τ \\ 1 & 0 & 0 \\ 0 & 0 & 0\end{matrix} ] [ \begin{matrix}{κ}_{Φ} \\ Φ \\ {𝓊}_{Φ}\end{matrix} ] ( ξ ) + [ \begin{matrix}0 \\ 0 \\ 1\end{matrix} ] {δ𝓊}_{Φ} ( ξ ) \qquad ( 14 )$$

Where δu may be the change in the state of the control input.

Once Equations (13) and (14) are developed according to the desired one or more boundary constraints, and one or more operational objectives, a control logic may be executed as noted in block 508. In a general representation, the controller logic, which may be based on a constrained optimization problem as detailed in the foregoing may be generalized as follows:

$${min}_{x , 𝓊} J ( x , 𝓊 ) such that \qquad ( 15 )$$

$$\dot{x} = f ( x ( ξ ) , 𝓊 ( ξ ) )$$

$$x ( ξ ) ∈ {C}_{1} , for all ξ$$

$$𝓊 ( ξ ) ∈ {C}_{2} , for all ξ$$

Where J may represent an objective function which, when minimized, may converge on a scenario directed to optimal performance of a drilling system, as discussed above in FIG. 1. In this context, performance may be defined in non-limiting terms as reduction of tortuosity, wellbore length, limited change in downlink commands, reduction in time spent drilling, minimization of final offset from target, or a weighted combination thereof. With continued reference to the formula for the controller logic, x may be the state of the system which may be a function of curvature, position, and/or attitude, which may further be a function of inclination and azimuth. The variable u, which has previously been identified as the state of the control input, is further described herein what may be a function of WOB and TF. The function ƒ may represent the characterization of the relationship between WOB, DLS, and TF, directed to the relationship as previously presented. The constraints on the state, x, which may be used to put upper and lower bounds on the attitude, curvature, tortuosity, and/or position may be represented as x(ξ)ϵC₁, while the constraints which may be used to bound the control inputs, u, maybe represented as u(ξ)ϵC₂. The target specifications may be given in terms of 3-dimensional position, attitude, and/or curvature, and may further be provided in either relative or absolute terms.
With continued reference to block 508, applying the general representation of the controller logic described above in Equation (15) to previously developed Equations (13) and (14) may result in the optimization problem being formulated as:

$${min}_{δ {𝓊}_{Θ} , δ {𝓊}_{Φ}} J ( {x}_{Θ} , {x}_{Φ} ) such that \qquad ( 16 )$$

$${\dot{x}}_{Θ} = {Ax}_{Θ} + B δ {u}_{Θ}$$

$${\dot{x}}_{Φ} = {Ax}_{Φ} + B {δ𝓊}_{Φ} \qquad ( 17 )$$

$$\sqrt{{𝓊}_{Θ}^{2} + {𝓊}_{Φ}^{2}} \leq {p}_{𝓊} \qquad ( 18 )$$

$${C}_{1} ( {x}_{Θ} , {x}_{Φ} ) \leq 0 \qquad ( 19 )$$

Where J(x_{Θ}, x_{Φ}), may be the cost function formulated based on an objective, and C may represent a set of additional constraints on the states and the control inputs which in a non-limiting example may include x_{Θ}=[κ_{Θ}, Θ, u_{Θ}]; and x_{Φ}=[κ_{Φ}, Φ, u_{Φ}]. In some examples, the cost function may be based on reducing or minimizing the wellbore tortuosity, deviations from a well plan, the wellbore length, reducing or limiting the change in downlink commands, reducing or minimizing the time spent drilling, reducing or minimizing a final offset from a target location, or a weighted combination thereof.

Block 508 of workflow 500 performs operations on information handling system 131 (e.g., referring to FIG. 1) utilizing a controller logic that is run by information handling system 131. The controller login in block 508 may operate as a receding horizon optimal control problem in conjunction with the constrained equations developed in blocks 502-506 to generate recommended operational drilling parameters, as denoted in block 510 of FIG. 5. These operational drilling parameters may also be known as control commands. The recommended control commands identified in block 510 may be identified by minimizing a cost function according to one or more selected constraints. The control commands may be determined for one or more target points simultaneously. In some examples, the one or more target points may be further defined as points, surfaces, or volumes. In additional examples, the wellbore propagation dynamics of the system as given in (16) and (17) may be a function of time or may be determined based on time.

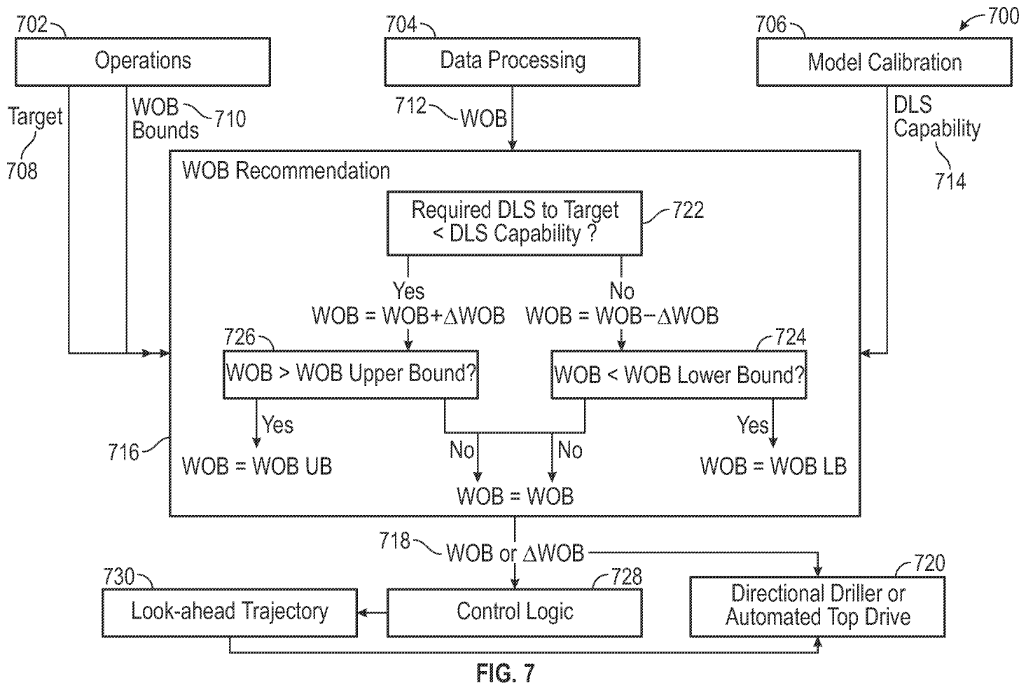

FIG. 7 may illustrate workflow 700 for choosing weight on bit for a drilling operation. As illustrated, workflow 700 may begin with inputs including operational parameters 702, data processing 704, and/or model calibration 706. In a non-limiting example, the inputs may include the target, WOB bounds, current WOB, and DLS capabilities. Workflow 500 (e.g., referring to FIG. 5) may provide inputs 702, 704, and/or 706. For example, operational parameters in block 702 may correlate with the constraints identified in block 504, as described above. In block 702, utilizing block 504, a target path 708 may be created by personnel by taking into consideration DLS. Additionally, WOB bounds 710 may be set, as described in block 504.

With continued reference to FIG. 7, data processing in block 704 may be performed by information handling system 131 (e.g., referring to FIG. 1). The data processing in block 704 may correlate with block 508 in FIG. 5, as discussed above. This may lead to an output of WOB 712. Additionally, block 706 may operate and function to create a model and perform model calibrations. This may correlate to block 502 in FIG. 5, as discussed above, and may lead to identified DLS capabilities 714.

The resulting WOB 712 as well as the WOB bounds 710, which may comprise the upper and lower bounds as determined from the previous calculations, may function as an input to a WOB decision process 716. WOB decision 718 resulting from the WOB decision process 716 may result in operational modifications to the drilling process made by the automated top drive or the directional driller 720. WOB decision 718 resulting from the WOB decision process 716 may include determining whether WOB should be increased, decreased, or maintained. DLS capabilities 714 identified to achieve the desired wellbore trajectory may be computed and compared against the empirically determined DLS capability 714 of the tool using information handling system 131 (e.g., referring to FIG. 1). As depicted in block 722, if the tool's DLS capability 714 is larger than what's required by the well plan trajectory, including a safety factor, then it may be advised to increase WOB by a predetermined amount. In this scenario, the decision-making process would progress from block 722 to block 726. If the tool is not capable of building the required DLS to achieve the desired wellbore trajectory then it may be advised to decrease WOB in order to maximize DLS capability 714 of the tool. In this scenario, the decision-making process would progress from block 722 to block 724. As depicted in blocks 724 and 726, the decision to increase, decrease, or maintain the WOB may also be considered in view of the WOB Upper Bound and the WOB Lower Bound. Depending on the results from block 722, the operational decision to modify the WOB is made in either blocks 724 or 726. As depicted in block 726, if resulting WOB 712 is greater than the WOB Upper Bound, then the WOB Upper Bound may be selected for operational execution as WOB decision 718. With continued reference to block 726, if resulting WOB 712 is less than the WOB Upper Bound, then the resulting WOB 712 may be selected for operational execution as WOB decision 718. In block 724, if resulting WOB 712 is greater than the WOB Lower Bound, then resulting WOB 712 may be selected for operational execution as WOB decision 718. Likewise, if resulting WOB 712 is less than the WOB Lower Bound in block 724, then the WOB Lower Bound may be selected for operational execution as WOB decision 718. In an automated or semi-automated process, WOB decision 718 may be relayed to drilling tools such as a top drive by way of a control logic 728 with assistance from a look-ahead trajectory 730. If the processes aren't fully automated, then WOB decision 718 may be relayed to directional driller 720.

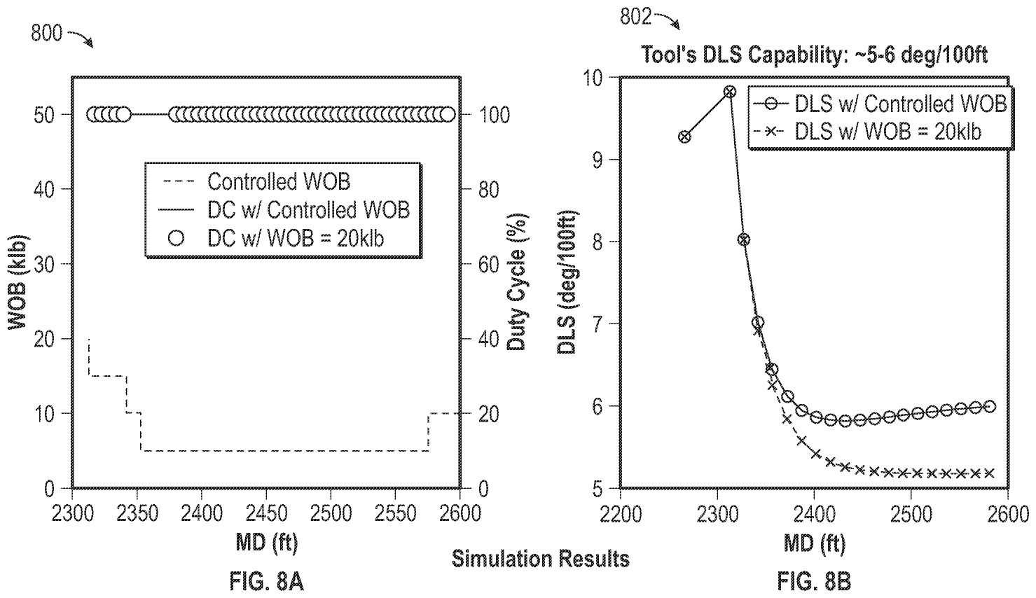

As can be seen in FIGS. 8A and 8B, simulations have been conducted for two scenarios to determine whether the aforementioned methodology may result in less deviations from the well path trajectory. Graphs 800 and 802 display the results from the simulations. A variety of directional drilling tools with a range of DLS capabilities may have been simulated to assess the utility of the aforementioned methodology for a well plan requiring a 7 deg/100 ft DLS through a curve section ranging from 75 to 90 degrees in inclination. A wellbore propagation model may have been used to simulate drilling parameters such as inclination, azimuth, build rate, and walk rate for scenarios including maintaining a constant WOB of 20 klb and modifying the WOB with controlled 5 klb increments. Example simulation results which modeled a tool capable of a DLS of about a 5 deg/100 ft are presented in FIG. 8A-B. The advantage of a range of WOBs may have been analyzed according to the resulting DLS. Decreasing the WOB to the minimal value of 5 klb may have resulted in adequate DLS which further resulted in less deviation from the planned well trajectory at landing.

The proposed methods and systems are an improvement over prior technology in that the WOB control problem is calculated in terms of the steering performance of the tool. In a non-limiting example, this may be beneficial to well plans with high dog-leg severity where geological and other downhole uncertainties may affect the capabilities of the tool. In some examples this may result in a failure to meet the steering objectives. Current technology focuses on ROP objectives (drilling quickly) and steering objectives (drilling accurately) as separate entities which are not solved simultaneously or mutually determined. The current method considers both drilling quickly and drilling accurately in order to achieve both objectives simultaneously.

Many of the equipment and services used to construct a wellbore may be charged on a per-day or per-time basis, therefor there may be an economic incentive to reduce capital expenditure by drilling a wellbore as quickly as possible. As previously alluded to, the realized reduction in cost achieved by maximizing ROP may result in wellbore tortuosity which may further hinder or even prohibit the successful completion of future wellbore operations in the deviated well. Given the indirect relationship between ROP and wellbore trajectory accuracy, it is beneficial to have a methodology to simultaneously optimize the accuracy and speed at which a wellbore is drilled.

The systems and methods may include any of the various features disclosed herein, including one or more of the following statements. The systems and methods may include any of the various features disclosed herein, including one or more of the following statements.

Statement 1. A method may comprise generating one or more measurements of at least a first drilling parameter and a second drilling parameter, determining a relationship between the first drilling parameter and the second drilling parameter, creating one or more constraints from the relationship, and minimizing a cost function using the one or more constraints. The method may further comprise calculating one or more control commands based at least in part on the minimizing the cost function and the one or more constraints, and updating a drilling operation according to the one or more control commands.

Statement 2. The method of statement 1, wherein the first drilling parameter and the second drilling parameter comprise a weight-on-bit, a dog-leg severity, a steering ratio, a build rate, or a tool face, and wherein the first drilling parameter and the second drilling parameter are not the same parameter.

Statement 3. The method of any of the preceding statements, wherein the relationship between the first drilling parameter and the second drilling parameter comprises a linear relationship.

Statement 4. The method of any of the preceding statements, wherein the relationship between the first drilling parameter and the second drilling parameter comprises a non-linear relationship.

Statement 5. The method of any of the preceding statements, wherein the one or more constraints comprise a first weight-on-bit constraint and a second weight-on-bit constraint, and wherein the first weight-on-bit constraint comprises an upper bound and the second weight-on-bit constraint comprises a lower bound.

Statement 6. The method of any of the preceding statements, wherein the minimizing the cost function comprises one or more cost functions based at least in part on a wellbore tortuosity, a deviation from well plan, a wellbore length, a limited change in downlink commands, a time spent drilling, a final offset from target, or a weighted combination thereof.

Statement 7. The method of any of the preceding statements, wherein the updating the drilling operation occurs autonomously.

Statement 8. The method of any of the preceding statements, wherein the one or more control commands comprise a weight-on-bit, a tool face, a flow rate, a rotations per minute, a steering ratio, or a combination thereof.

Statement 9. The method of any of the preceding statements, wherein the determining the relationship between the first drilling parameter and the second drilling parameter further comprises developing a nominal relationship based at least in part on a drilling model, a data acquired from historical drilling operations, or a combination thereof.

Statement 10. The method of statement 9, wherein the determining the relationship between the first drilling parameter and the second drilling parameter further comprises updating the nominal relationship based at least in part on real-time data.

Statement 11. A system may comprise a first sensor disposed on a first piece of drilling equipment to measure a first drilling parameter, a second sensor disposed on a second piece of drilling equipment to measure a second drilling parameter, and an information handling system connected to the first sensor and the second sensor. The information handling system may update a relationship between the first drilling parameter and the second drilling parameter, create one or more constraints from the relationship, perform a minimization of the relationship based at least in part on the one or more constraints, and calculate one or more control commands based at least in part on the minimization of the cost function and the one or more constraints.

Statement 12. The system of statement 11, wherein the first drilling parameter and the second drilling parameter comprise a weight-on-bit, a dog-leg severity, or a tool face, and wherein the first drilling parameter and the second drilling parameter are not the same parameter.

Statement 13. The system of any of the preceding statements 11 to 12, wherein the relationship between the first drilling parameter and the second drilling parameter comprises a linear relationship.

Statement 14. The system of any of the preceding statements 11 to 13, wherein the relationship between the first drilling parameter and the second drilling parameter comprises a non-linear relationship.

Statement 15. The system of any of the preceding statements 11 to 14, wherein the first piece of drilling equipment and the second piece of drilling equipment are disposed at a surface of a wellbore or a bottom hole assembly.

Statement 16. The system of any of the preceding statements 11 to 15, wherein the minimization of the cost function comprises one or more cost functions based at least in part on a wellbore tortuosity, a deviation from well plan, a wellbore length, a limited change in downlink commands, a time spent drilling, a final offset from target, or a weighted combination thereof.

Statement 17. The system of any of the preceding statements 11 to 16, wherein the one or more constraints comprises a first constraint and a second constraint, and wherein the first constraint comprises an upper bound and the second constraint comprises a lower bound.

Statement 18. The system of statement 17, wherein the one or more constraints comprises a weight-on-bit.

Statement 19. The system of any of the preceding statements 11 to 17, wherein the one or more control commands comprise a weight-on-bit, a tool face, a flow rate, a rotations per minute, a steering ratio, or a combination thereof.

Statement 20. The system of any of the preceding statements 11 to 17 and 19, further comprising a nominal relationship between the first drilling parameter and the second drilling parameter, wherein the nominal relationship is based at least in part on a drilling model, a data acquired from historical drilling operations, a real-time data, or a combination thereof.

Although the present disclosure and its advantages have been described in detail, it should be understood that various changes, substitutions and alterations may be made herein without departing from the spirit and scope of the disclosure as defined by the appended claims. The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
generating one or more measurements of at least a first drilling parameter and a second drilling parameter;
determining a relationship between the first drilling parameter and the second drilling parameter;
creating one or more constraints from the relationship;
minimizing a cost function using the one or more constraints;
calculating one or more control commands based at least in part on the minimizing the cost function and the one or more constraints; and
updating a drilling operation according to the one or more control commands.

2. The method of claim 1, wherein the first drilling parameter and the second drilling parameter comprise a weight-on-bit, a dog-leg severity, a steering ratio, a build rate, or a tool face, and wherein the first drilling parameter and the second drilling parameter are not the same parameter.

3. The method of claim 1, wherein the relationship between the first drilling parameter and the second drilling parameter comprises a linear relationship.

4. The method of claim 1, wherein the relationship between the first drilling parameter and the second drilling parameter comprises a non-linear relationship.

5. The method of claim 1, wherein the one or more constraints comprise a first weight-on-bit constraint and a second weight-on-bit constraint, and wherein the first weight-on-bit constraint comprises an upper bound and the second weight-on-bit constraint comprises a lower bound.

6. The method of claim 1, wherein the minimizing the cost function comprises one or more cost functions based at least in part on a wellbore tortuosity, a deviation from well plan, a wellbore length, a limited change in downlink commands, a time spent drilling, a final offset from target, or a weighted combination thereof.

7. The method of claim 1, wherein the updating the drilling operation occurs autonomously.

8. The method of claim 1, wherein the one or more control commands comprise a weight-on-bit, a tool face, a flow rate, a rotations per minute, a steering ratio, or a combination thereof.

9. The method of claim 1, wherein the determining the relationship between the first drilling parameter and the second drilling parameter further comprises developing a nominal relationship based at least in part on a drilling model, a data acquired from historical drilling operations, or a combination thereof.

10. The method of claim 9, wherein the determining the relationship between the first drilling parameter and the second drilling parameter further comprises updating the nominal relationship based at least in part on real-time data.

11. A system, comprising:
a first sensor disposed on a first piece of drilling equipment to measure a first drilling parameter;
a second sensor disposed on a second piece of drilling equipment to measure a second drilling parameter;
an information handling system connected to the first sensor and the second sensor that:
updates a relationship between the first drilling parameter and the second drilling parameter;
creates one or more constraints from the relationship;
performs a minimization of the relationship based at least in part on the one or more constraints; and
calculates one or more control commands based at least in part on the minimization of the cost function and the one or more constraints.

12. The system of claim 11, wherein the first drilling parameter and the second drilling parameter comprise a weight-on-bit, a dog-leg severity, or a tool face, and wherein the first drilling parameter and the second drilling parameter are not the same parameter.

13. The system of claim 11, wherein the relationship between the first drilling parameter and the second drilling parameter comprises a linear relationship.

14. The system of claim 11, wherein the relationship between the first drilling parameter and the second drilling parameter comprises a non-linear relationship.

15. The system of claim 11, wherein the first piece of drilling equipment and the second piece of drilling equipment are disposed at a surface of a wellbore or a bottom hole assembly.

16. The system of claim 11, wherein the minimization of the cost function comprises one or more cost functions based at least in part on a wellbore tortuosity, a deviation from well plan, a wellbore length, a limited change in downlink commands, a time spent drilling, a final offset from target, or a weighted combination thereof.

17. The system of claim 11, wherein the one or more constraints comprises a first constraint and a second constraint, and wherein the first constraint comprises an upper bound and the second constraint comprises a lower bound.

18. The system of claim 17, wherein the one or more constraints comprises a weight-on-bit.

19. The system of claim 11, wherein the one or more control commands comprise a weight-on-bit, a tool face, a flow rate, a rotations per minute, a steering ratio, or a combination thereof.

20. The system of claim 11, further comprising a nominal relationship between the first drilling parameter and the second drilling parameter, wherein the nominal relationship is based at least in part on a drilling model, a data acquired from historical drilling operations, a real-time data, or a combination thereof.
